(19) United States
(12) Patent Application Publication
(10) Pub. No.: US 2007/0236974 A1
(43) Pub. Date: Oct. 11, 2007

(54) Amplification Apparatus

(75) Inventor: Masao Noro, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 11/690,197

(22) Filed: Mar. 23, 2007

(30) Foreign Application Priority Data
Apr. 11, 2006 (JP) 2006-108783

(51) Int. Cl. H02J 1/10

(52) U.S. Cl. 363/65

(57) ABSTRACT

A switching regulator raises power from a USB terminal to 100 V, and performs the charging of an electrolytic capacitor. After the charging has been completed, a switching regulator drops the voltage to 5 V, and supplies the power to an amplifier. When the power consumed by the amplifier exceeds the maximum power to be supplied in accordance with the USB standard, the charge accumulated in the electrolytic capacitor is discharged, and for use, the switching regulator drops the power to 5 V. Thus, when the power consumed exceeds the maximum power to be supplied by the USB terminal, the amplifier can be driven without any problem.

### BACKGROUND OF THE INVENTION

The present invention relates to a technique for an amplification apparatus that amplifies and outputs a signal.

USB (Universal Serial Bus) standard terminals are widely employed for personal computers, and via these. USB terminals, various types of peripheral devices can be connected, as needed, to personal computers.

Since a USB standard terminal includes a signal line and a power line, a peripheral device connected to a USE terminal can receive power via the power line. In this case, according to the USB standard, since the power provided is limited to a current of 0.5 A or lower, the upper limit of the available power is 2.5 W.

Since among the apparatuses that can be connected to a USB terminal, there are an apparatus that consumes power in excess of 2.5 W, a apparatus disclosed in patent document 1 that can cope with this problem has been proposed.

According to the apparatus described in patent document 1, a capacitor is provided for an input unit that receives power from the power line of the USB terminal, and power accumulated in the capacitor is used to supplement the normally available power to satisfy peak power needs of the peripheral device connected to the USB terminal.

### Patent Document 1: JP-T-2004-503199

However, since simply a capacitor is employed for the apparatus described in patent document 1, only a small charge can be accumulated on the capacitor. And since an extremely large capacitor would be required to increase the amount of the charge that can to be accumulated, this would adversely affect and hinder the downsizing of the apparatus. Especially for a USB amplifier that drives a small loudspeaker, connected to the USB terminal, the size would be increased, so that the amplifier may be no longer of no practical use.

Since an electric double layer type capacitor possessing a large capacitance has been developed, such a capacitor could be employed. However, because this type of capacitor has a high equivalent resistance and a correspondingly large power loss, such a capacitor could not be employed as a power source for an amplifier that drives a 4 to 8 ohm loudspeaker.

Further, a capacitor has been developed for which a large capacitance is provided by an increase in density, which permits a large current to be handled. But while for this capacitor the resistance is low, the withstand voltage is reduced to about 2 V, and thus the capacitor cannot be employed at the operating voltage of an amplifier. In this case, although the withstand voltage could be raised by connecting a plurality of capacitors in series, an additional circuit would be required to maintain a voltage balance, and the circuit structure would become complicated and the cost would be increased. As a result, such a capacitor is not practical for this type of use.

### SUMMARY OF THE INVENTION

In order to solve these problems, one objective of the present invention is to provide an amplification apparatus that can perform driving using a high output supplied to compensate for peak power consumption, regardless of whether a power source that supplies low power is still at the maximum, and that can be compactly made.

In order to solve the above object, the present invention has the following arrangements.

(1) An amplification apparatus comprising:

a first DC-DC converter that raises a voltage of a DC power source supplied to an input side thereof and outputs power of the raised voltage;

a capacitor connected to an output side of the first DC-DC converter;

a second DC-DC converter that receives the power from the first DC-DC converter and the capacitor, drops a voltage of the received power and outputs the power of the dropped voltage; and

an amplification circuit that amplifies a received signal using the power output from the second DC-DC converter as a power source.

### (2) The amplification apparatus according to (1), wherein the capacitor includes an electrolytic capacitor.

(3) The amplification apparatus according to (1), wherein the DC power source is a power source obtained through a power line provided at an output side of a USE standard terminal, and the received signal is a signal obtained through a signal line provide at the output side of the USB standard terminal.

### (4) The amplification apparatus according to (3) further comprising a DA converter arranged on an input side of the amplification circuit for digital-analog converting the signal obtained through the signal line.

(5) An amplification apparatus comprising:

a first DC-DC converter that raises a voltage of a DC power source supplied to an input side thereof and outputs power of the raised voltage;

a capacitor connected to an output side of the first DC-DC converter;

a second DC-DC converter that receives the power from the first DC-DC converter and the capacitor, drops a voltage of the received power and outputs the power of the dropped voltage;

an amplification circuit that amplifies a received signal;

a current detector that detects a current value of a current output by the DC power source; and

a switching circuit that supplies the current from the DC power source to the amplification circuit when the current value detected by the current detector does not exceed a predetermined value, and supplies power output by the second DC-DC converter to the amplification circuit when the current value is greater than the predetermined value.

### (6) The amplification apparatus according to (5) further comprising a third DC-DC converter arranged on a path along which a current is supplied by the DC power source to the amplification circuit for raising the voltage of the DC power source.

### (7) The amplification apparatus according to (5), wherein the capacitor includes an electrolytic capacitor.

(8) The amplification apparatus according to (5), wherein the DC power source is a power source obtained through a power line provided at an output side of a USB standard terminal, and the received signal is a signal obtained through a signal line provide at the output side of the USB standard terminal.

### (9) The amplification apparatus according to (8) further comprising a DA converter arranged on an input side of the amplification circuit for digital-analog converting the signal obtained through the signal line.

(10) A amplifying method for an amplification apparatus that includes a first DC-DC converter, a capacitor connected to an output side of the first DC-DC converter, a second DC-DC converter connected to the output side of the first DC-DC converter and an amplification circuit connected to the second DC-DC converter, the method comprising:

raising a voltage of a DC power source supplied to an input side thereof and outputting power of the raised voltage by the first DC-DC converter;

receiving the power from the first DC-DC converter and the capacitor, dropping a voltage of the received power and outputting the power of the dropped voltage by the second DC-DC converter; and

amplifying a received signal using the power output from the second DC-DC converter as a power source by the amplification circuit.

### (11) The amplifying method according to (10), wherein the capacitor includes an electrolytic capacitor.

(12) The amplifying method according to (10), wherein the DC power source is a power source obtained through a power line provided at an output side of a USB standard terminal, and the received signal is a signal obtained through a signal line provide at the output side of the USB standard terminal.

### (13) The amplifying method according to claim (12) further comprising a DA converter arranged on an input side of the amplification circuit for digital-analog converting the signal obtained through the signal line.

(14) A amplifying method for an amplification apparatus that includes a first DC-DC converter, a capacitor connected to an output side of the first DC-DC converter, a second DC-DC converter connected to the output side of the first DC-DC converter, and an amplification circuit connected to the second DC-DC converter, the method comprising:

raising a voltage of the DC power source supplied to an input side thereof and outputting power of the raised voltage by the first DC-DC converter;

receiving the power from the first DC-DC converter and the capacitor, dropping a voltage of the received power and outputting the power of the dropped voltage by the second DC-DC converter;

amplifying a received signal by the amplification circuit;

detecting the current value of the current output by the DC power source; and

supplying the current from the DC power source to the amplification circuit when the current value detected by the current detector does not exceed a predetermined value, and supplying power output by the second DC-DC converter to the amplification circuit when the current value is greater than the predetermined value.

### (15) The amplifying method according to (14) further comprising raising the voltage of the DC power source by a third DC-DC converter arranged on a path along which a current is supplied by the DC power source to the amplification circuit.

### (16) The amplifying method according to (14), wherein the capacitor includes an electrolytic capacitor.

(17) The amplifying method according to (14), wherein the DC power source is a power source obtained through a power line provided at an output side of a USB standard terminal, and the received signal is a signal obtained through a signal line provide at the output side of the USB standard terminal.

### (18) The amplifying method according to (17) further comprising digital-analog converting the signal obtained through the signal line by a DA converter arranged on an input side of the amplification circuit.

### BRIEF DESCRIPTION OF THE DRAWINGS

FIG. 1 is a circuit diagram showing the arrangement of an amplification apparatus according to a first embodiment of the present invention.

FIG. 2 is a circuit diagram showing an example circuit employed instead of a switching regulator in FIG. 1.

FIG. 3 is a circuit diagram showing an example circuit employed instead of the switching regulator in FIG. 1.

FIG. 4 is a circuit diagram showing the arrangement of an amplification apparatus according to a second embodiment of the present invention.

FIG. 5 is a circuit diagram showing a modification of the second embodiment in FIG. 4.

FIG. 6 is a circuit diagram showing an example circuit employed instead of a comparator shown in FIGS. 4 and 5.

### DETAILED DESCRIPTION OF PREFERRED EMBODIMENTS

The preferred embodiments of the present invention will now be described while referring to the drawings.

### A: First Embodiment

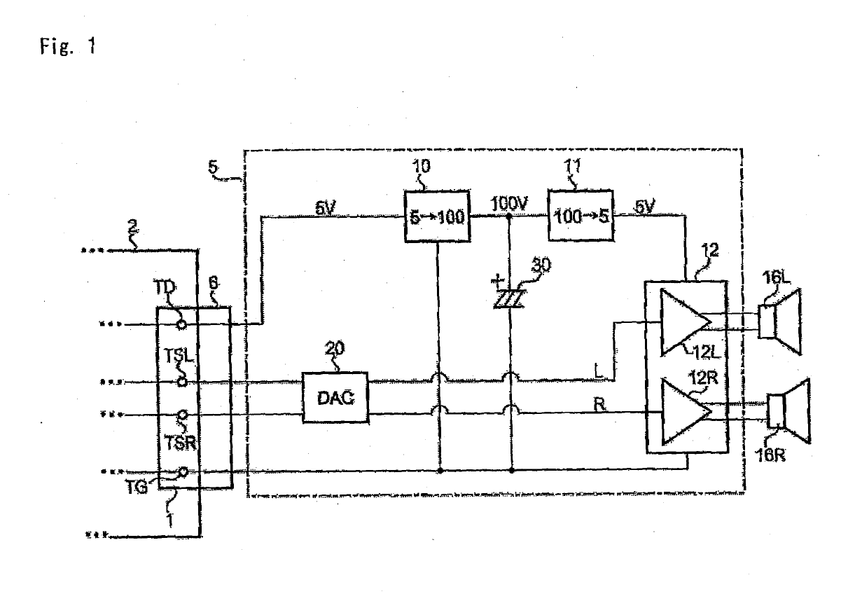

FIG. 1 is a circuit diagram showing a circuit of an amplification apparatus according to a first embodiment of the present invention. In FIG. 1, a USB terminal 1 provided in a personal computer 2 includes a power terminal TD of 5 V, a ground terminal TG and stereo signal terminals TSL and TSR. An amplification apparatus 5 is connected to the USB terminal 1 via a USB plug 6.

When a voltage of 5 V is applied by the power terminal TD to the input terminal of a switching regulator 10, the switching regulator 10 raises this voltage to a direct current of 100V and outputs this direct current via an output terminal to a switching regulator 11 which drops the 100 V direct current to 5 V and outputs this voltage to an amplifier 12. In this case, the amplifier 12 is a 5 V amplifier in which are provided an amplifier 12L, for an L channel, and an amplifier 12R, for an R channel. Loudspeakers 16L and 16R are respectively connected to the amplifiers 12R and 12R.

A DA converter 20 converts digital signals output from the L channel and the R channel via the signal terminals TSL and TSR of the USB terminal 1, into analog signals, and transmits these signals to the input terminals of the amplifiers 12L and 12R.

An electrolytic capacitor 30 shown in FIG. 1 is located between the output side of the switching regulator 10 and the ground. The electrolytic capacitor 30 will now be described.

### (Discharge Period Required for the Electrolytic Capacitor 30)

First, a discharge period required for the electrolytic capacitor 30 will be explained.

It is known that there is a large difference between a peak output of a musical tone signal and an average output thereof. This difference varies depending on music genres and music pieces, but generally, the average output is supposed to be ⅛ to 1/10 of the peak output. Relying on this relationship, it can be understood, if the peak power can be temporarily supplemented, the amplifier can be driven by ⅛ to 1/10 the maximum power at the peak all time other than when the power peak is reached. Further, through experiments performed by the present inventor, it was found that, regardless of the music genre, the length of a continuing peak power period was about 0.2 s.

Therefore, so long as the maximum power can be supplied for 0.2 s, at other times, the amplifier need only be driven by low power for music to be played at the same tonal volume as when the amplifier is driven by a large capacity power source. For example, when 20 W can be continuously supplied for 0.2 s, no problem is encountered if the average power, other than at the peak, is equal to or lower than 2.5 W. Thus, even with a power source satisfying the USB standard, the amplifier can be substantially driven by a power (in watts) of 20 W (10 W×2 ch). That is, a discharge period for the electrolytic capacitor 30 is so designated that the maximum power can be maintained for a period of 0.2 s.

### (Size of the Electrolytic Capacitor 30)

However, even in a case wherein for the power voltage a drop to 4 V is permitted, based on the assumption that an amplifier having a power voltage of 5 V is to be driven, an extremely large capacitance of about 0.8 F is required in order to supply 20 W for a period of 0.2 s. When this capacitance is provided by using an electrolytic capacitor having a capacitance of about 0.8 F (0.8 F=800000 μF), there is too great an increase in the volume of the electrolytic capacitor 30 for it to be of practical use.

Therefore, according to this embodiment, the size of the electrolytic capacitor 30 is reduced as follows.

First, charges Q which are accumulated in the electrolytic capacitor 30 are expressed by

Q=C·V,

where C represents capacitance and V represents a voltage to be applied,

and energy E is expressed by

E=C·V²/2.

As described above, in a case that a drop to 4 V is permitted for the power voltage supplied to the amplifier 12, a capacitor having a capacitance of about 0.8 F is required in order for 20 W to be supplied for a period of 0.2 s.

When a voltage of 5 V has been accumulated in the capacitor of 0.8 F, the energy to be discharged before the voltage is dropped to 4 V is

0.8F×5V×5V×½−0.8F×4V×4V×½=3.6 J.

Furthermore, based on the assumption that a case is one wherein 3.6 J of energy is accumulated using a voltage of 100 V, and that thereafter a very efficient switching regulator is employed to drop the voltage to 5 V, where C represents the capacitance required to discharge 3.6 J of energy, the following expression is satisfied:

C×100V×100V×½−C×5V×5V×½=3.6 J,

and the value of C that satisfies this expression is 722 μF.

The size of the electrolytic capacitor 30 is determined by the product of the capacitance and the voltage that is to be applied (C·V). Thus, when the 0.8 F at 5 V case is compared with the 722 μF at 100 V case,

a: 0.8×5=4 (Q)

b: 722μ×100=72200μ(Q).

### And the ratio for these two is

4(Q)·/72200μ(Q)=55.4.

That is, it is found that the size of the electrolytic capacitor 30 can be reduced to about 1/55 that of the original. Specifically, 722μ can be easily obtained by arranging in parallel two electrolytic capacitor shaving a diameter of several tens millimeters.

As is apparent from the above description, the capacitance of the electrolytic capacitor 30 in FIG. 1 is set at about 722μ, and for this, two electrolytic capacitors of about 360 μF, having a diameter of ten-odd millimeters each, are arranged in parallel. In this case, since the electrolytic capacitor 30 is sufficiently small, the resultant amplification apparatus can be maintained as a small appropriate apparatus for connection to the USB terminal 1.

The operation of the amplification apparatus 5 having the above arrangement will now be described. First, when power is supplied by the USB terminal 1, the switching regulator 10 raises the voltage to 100 V, and charging of the electrolytic capacitor 30 is performed using this voltage value. After the charging has been completed, the switching regulator 11 drops the voltage of the power output by the switching regulator 10 and supplies the resultant power of 5 V to the amplifier 12.

In this state, when stereo signals are output for the L channel and the R channel, the DA converter converts these signals into analog signals that it transmits to the amplifiers 12L and 12R. The amplifiers 12L and 12R amplify the analog signals, and sounds for the left and right channels are output by the loudspeakers 16L and 16R.

Depending on the relationship between the gain of the amplifier and the values of the signals input to the amplifier 12, the power consumed by the amplifier 12 might exceed the maximum power that can be supplied by the power terminal TD of the USB terminal 1. Therefore, power exceeding the maximum power to be supplied can not be output by the switching regulator 10. In this embodiment, when this state is encountered, the charge accumulated in the electrolytic capacitor 30 is supplementarily discharged to compensate for the shortage, and for use, the switching regulator 11 drops the power to 5 V.

Through this processing, when power exceeds the maximum power supplied by the USB terminal 1, the amplifier 12 can be driven continuously. At this time, when a signal input to the amplifier 12 maintains a peak value, power is still supplied to the amplifier 12 for a period of 0.2 s. Thus, for normal music, playing is continued without any problem. As a result, the maximum volume of 20 W (10 W×2 ch) is substantially obtained.

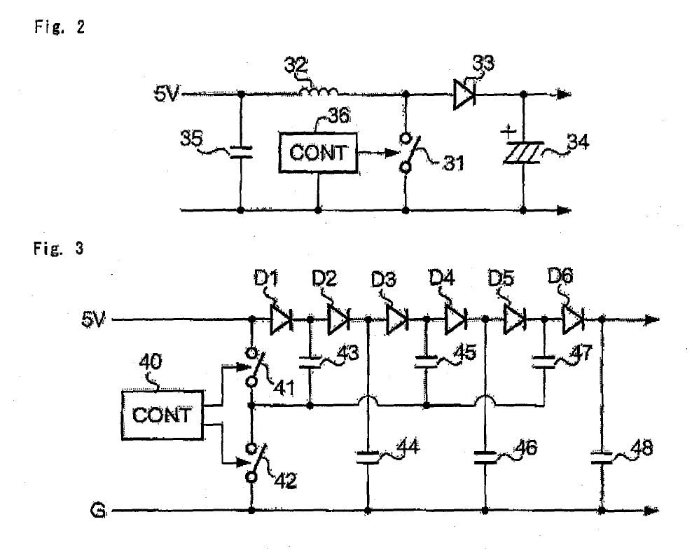

A boosting circuit including an inductor, shown in FIG. 2, may also be employed as the circuit for the switching regulator 10. Referring to FIG. 2, a controller 36 turns on or off a switch 31 to generate an induced current in the inductor 32, which then performs boosting. A rectifying diode 33, an electrolytic capacitor 34 used for smoothing, and a capacitor 35 for holding charges are also included in the circuit.

In addition, a rectifying circuit in FIG. 3 including diodes D1 to D6 and capacitors 43 to 48 may be employed as the circuit for the switching regulator 10. In this circuit, a controller 40 turns on or off switches 41 and 42, as needed, and the potentials of the capacitors 43 to 48 are superimposed to generate a high voltage.

### B: Second Embodiment

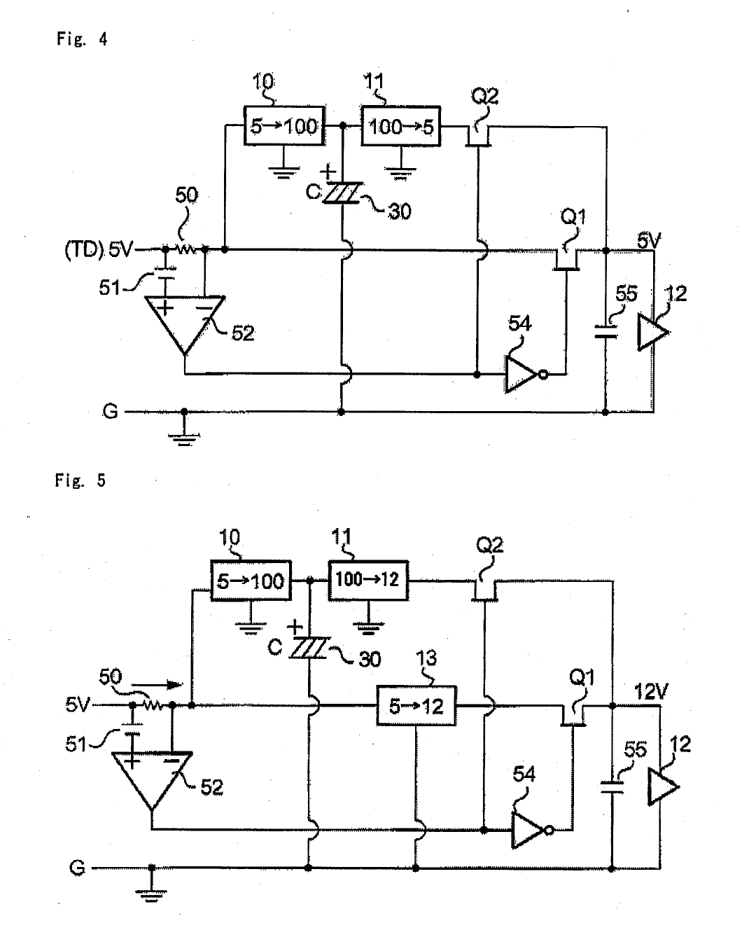

A second embodiment according to the present invention will now be described. FIG. 4 is a circuit diagram showing the arrangement of the second embodiment of this invention. In FIG. 4, the same reference numerals as those used in FIG. 1 are employed to denote corresponding components, and no further explanation for them will be given.

In FIG. 4, one end of a current detection resistor 50 is connected to a power terminal TD for a USB terminal 1, and the other end is connected to the input side of a switching regulator 10 and also to the power terminal of an amplifier 12, via the drain and source of a transistor Q1. The output side of a switching regulator 11 is connected to the power terminal of the amplifier 12 via the drain and source of a transistor Q2.

A comparator 52 determines whether a current flowing across the current detection resistor 50 exceeds a predetermined value based on a voltage difference between the two terminals of the current detection resistor 50. A reference power source 51 generates a reference voltage. When the voltage drop at the current detection resistor 50 exceeds the voltage value for the reference power source 51, the comparator 52 outputs a signal at level H. The resistance of the current detection resistor 50 and the voltage value of the reference power source 51 are so designated that the comparator 52 outputs level H when the power consumed downstream of the current detection resistor 50 exceeds the maximum permissible value of the power consumed that conforms to the USB standard.

A signal output by the comparator 52 is transmitted to the gate of the transistor Q2 and to the gate of the transistor Q1, via an inverter 54. A capacitor 55 is located between the source of the transistor Q1 and the ground.

According to this arrangement, when power consumed by the amplifier does not exceed the power capacitance of the USB standard, the signal output by the comparator 52 is at level L, and therefore, the transistor Q2 is rendered off while the transistor Q1 is rendered on. As a result, the power is supplied to the amplifier 12 by the power terminal TD, via the transistor Q1. Further, in this state, since power in accordance with the USB standard still has more capacity, the charging of the electrolytic capacitor 30 is performed by the switching regulator 10.

When power consumed by the amplifier is increased, for example, at the signal peak time, the signal output by the comparator 52 goes to level H and the transistor Q2 is rendered on, while the transistor Q1 is rendered off. As a result, power is supplied to the amplifier 12 via the switching regulator 11 and the transistor Q2, and the discharge of the electrolytic capacitor 30 is performed to compensate for the shortage of power. Even when the peak signal is continued, the shortage of power can be compensated for in a maximum period of about 0.2 s.

Therefore, for normal music, playing can be continued without any problem. As a result, as in the first embodiment, a volume of a maximum 20 W (10 W×2 ch) can be substantially obtained. Furthermore, in the second embodiment, when the power consumed does not exceed the maximum permissible power, power is supplied to the amplifier 12 via the current detection resistor 50 and the transistor Q1, without the switching regulators 10 and 11 being required. Thus, there no loss is caused by these components, and the efficiency with which power used is extremely high.

In this embodiment, when the power voltage of the amplifier 12 is higher than 5 V, e.g., when the power voltage is 12 V, as shown in FIG. 5, a switching regulator 13 that raises a voltage from 5 V to 12 V need only be located between the current detection resistor 50 and the drain of the transistor Q1. In this case, the voltage output by the switching regulator 11 may be dropped from 100 V to 12 V, in consonance with the power voltage of the amplifier 12.

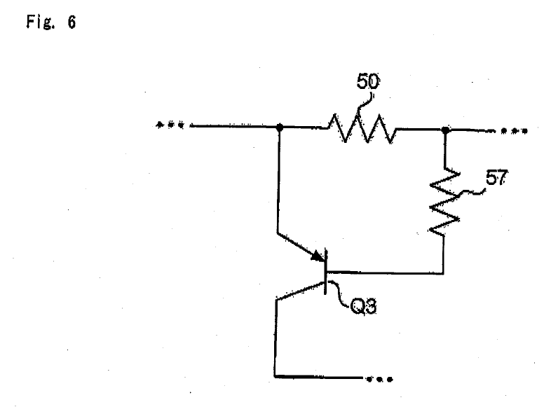

In addition, the comparator 52 and the reference power source 51 may be provided by using a circuit shown in FIG. 6. For a transistor Q3 shown in FIG. 6, the emitter is connected to one end of the current detection resistor 50, and the base is connected to the other end of the current detection resistor 50 via a bias resistor 57. The collector of the transistor Q3 corresponds to the output terminal of the comparator 52.

In the circuit in FIG. 6, appropriate resistances for the current detection resistor 50 and the bias resistor 57 should be designated relative to a voltage that is dropped in the forward direction between the base and emitter of the transistor Q3, and when the power consumed exceeds the maximum power consumed in accordance with the USB standard, the transistor Q1 should be turned on.

### C: Modification

The embodiments of the present invention have been described; however, this invention is not limited to these embodiments, and can be carried out by various other embodiments.

Further, in the embodiments, as a power source, a power feed line extending from the output terminal conforming to the USB standard is employed. However, another power source (battery source) that supplies a smaller amount of power can also be employed.

Furthermore, in the embodiment, the electrolytic capacitor 30 has been employed. However, so long as the withstand voltage, the size and the capacitance are appropriate, another type of capacitor may also be employed. In the second embodiment, the power consumed has been calculated based on the value of a current that flows via the current detection resistor 50. However, so long as the amount of power used on the output side of a power source (e.g., a USB power source) is obtained, any means can be employed.

What is claimed is:

1. An amplification apparatus comprising:
a first DC-DC converter that raises a voltage of a DC power source supplied to an input side thereof and outputs power of the raised voltage,
a capacitor connected to an output side of the first DC-DC converter;
a second DC-DC converter that receives the power from the first DC-DC converter and the capacitor, drops a voltage of the received power and outputs the power of the dropped voltage; and
an amplification circuit that amplifies a received signal using the power output from the second DC-DC converter as a power source.

2. The amplification apparatus according to claim 1, wherein the capacitor includes an electrolytic capacitor.

3. The amplification apparatus according to claim 1, wherein the DC power source is a power source obtained through a power line provided at an output side of a USB standard terminal, and the received signal is a signal obtained through a signal line provide at the output side of the USB standard terminal.

4. The amplification apparatus according to claim 3 further comprising a DA converter arranged on an input side of the amplification circuit for digital-analog converting the signal obtained through the signal line.

5. An amplification apparatus comprising:
a first DC-DC converter that raises a voltage of a DC power source supplied to an input side thereof and outputs power of the raised voltage;
a capacitor connected to an output side of the first DC-DC converter;
a second DC-DC converter that receives the power from the first DC-DC converter and the capacitor, drops a voltage of the received power and outputs the power of the dropped voltage;
an amplification circuit that amplifies a received signal;
a current detector that detects a current value of a current output by the DC power source; and
a switching circuit that supplies the current from the DC power source to the amplification circuit when the current value detected by the current detector does not exceed a predetermined value, and supplies power output by the second DC-DC converter to the amplification circuit when the current value is greater than the predetermined value.

6. The amplification apparatus according to claim 5 further comprising a third DC-DC converter arranged on a path along which a current is supplied by the DC power source to the amplification circuit for raising the voltage of the DC power source.

7. The amplification apparatus according to claim 5, wherein the capacitor includes an electrolytic capacitor.

8. The amplification apparatus according to claim 5, wherein the DC power source is a power source obtained through a power line provided at an output side of a USB standard terminal, and the received signal is a signal obtained through a signal line provide at the output side of the USB standard terminal.

9. The amplification apparatus according to claim 8 further comprising a DA converter arranged on an input side of the amplification circuit for digital-analog converting the signal obtained through the signal line.

10. A amplifying method for an amplification apparatus that includes a first DC-DC converter, a capacitor connected to an output side of the first DC-DC converter, a second DC-DC converter connected to the output side of the first DC-DC converter and an amplification circuit connected to the second DC-DC converter, the method comprising:
raising a voltage of a DC power source supplied to an input side thereof and outputting power of the raised voltage by the first DC-DC converter;
receiving the power from the first DC-DC converter and the capacitor, dropping a voltage of the received power and outputting the power of the dropped voltage by the second DC-DC converter; and
amplifying a received signal using the power output from the second DC-DC converter as a power source by the amplification circuit.

11. The amplifying method according to claim 10, wherein the capacitor includes an electrolytic capacitor.

12. The amplifying method according to claim 10, wherein the DC power source is a power source obtained through a power line provided at an output side of a USB standard terminal, and the received signal is a signal obtained through a signal line provide at the output side of the USB standard terminal.

13. The amplifying method according to claim 12 further comprising a DA converter arranged on an input side of the amplification circuit for digital-analog converting the signal obtained through the signal line.

14. A amplifying method for amplification apparatus that includes a first DC-DC converter, a capacitor connected to an output side of the first DC-DC converter, a second DC-DC converter connected to the output side of the first DC-DC converter, and an amplification circuit connected to the second DC-DC converter, the method comprising:
raising a voltage of the DC power source supplied to an input side thereof and outputting power of the raised voltage by the first DC-DC converter;
receiving the power from the first DC-DC converter and the capacitor, dropping a voltage of the received power and outputting the power of the dropped voltage by the second DC-DC converter;
amplifying a received signal by the amplification circuit;
detecting the current value of the current output by the DC power source; and
supplying the current from the DC power source to the amplification circuit when the current value detected by the current detector does not exceed a predetermined value, and supplying power output by the second DC-DC converter to the amplification circuit when the current value is greater than the predetermined value.

15. The amplifying method according to claim 14 further comprising raising the voltage of the DC power source by a third DC-DC converter arranged on a path along which a current is supplied by the DC power source to the amplification circuit.

16. The amplifying method according to claim 14, wherein the capacitor includes an electrolytic capacitor.

17. The amplifying method according to claim 14, wherein the DC power-source is a power source obtained through a power line provided at an output side of a USB standard terminal, and the received signal is a signal obtained through a signal line provide at the output side of the USB standard terminal.

18. The amplifying method according to claim 17 further comprising digital-analog converting the signal obtained through the signal line by a DA converter arranged on an input side of the amplification circuit.
